(19) United States
(12) Patent Application Publication
(10) Pub. No.: US 2013/0166349 A1
(43) Pub. Date: Jun. 27, 2013

(54) SYSTEM AND METHOD FOR PROVIDING ACCESS TO AN AUDIENCE

(71) Applicant: FanAxcess, Inc., Oakland, CA (US)

(72) Inventor: Joan MARTIN, Oakland, CA (US)

(73) Assignee: FANAXCESS, INC., Oakland, CA (US)

(21) Appl. No.: 13/713,920

(22) Filed: Dec. 13, 2012

Related U.S. Application Data
(60) Provisional application No. 61/630,957, filed on Dec. 23, 2011.
(60) Provisional application No. 61/630,958, filed on Dec. 23, 2011.
(60) Provisional application No. 61/630,959, filed on Dec. 23, 2011.

(51) Int. Cl. G06Q 30/02

(52) U.S. Cl. CPC G06Q 30/0201
USPC 705/7.29

(57) ABSTRACT

A method of matching a buyer and a seller of audience access includes storing a plurality of profiles associated with a respective plurality of performers by a computing system. Each of the plurality of performers offers access to an audience having one or more distinct characteristics. At least one of the distinct characteristics of the audience associated with each of the performers is determined. A discovery request is received from a requestor. The discovery request identifies one or more target audience characteristics. The computing system compares the one or more target audience characteristics of the discovery request with the determined at least one of the distinct characteristics of the audience. At least one of the plurality of performers matching the discovery request is identified based on the comparing. The identified at least one performer is output over the network in response to the request.

### CROSS-REFERENCE TO RELATED APPLICATIONS

This patent application claims the benefit of U.S. Provisional Patent Application Ser. No. U.S. 61/630,957 filed on Dec. 23, 2011 and entitled “System and Method for Providing Access to an Audience,” U.S. Provisional Patent Application Ser. No. 61/630,958 filed on Dec. 23, 2011 and entitled “System and Method for Managing Collateral Sponsorship,” and U.S. Provisional Patent Application Ser. No. 61/630,959 filed on Dec. 23, 2011 and entitled “System and Method for Feedback and Ranking of Audience Matching Service,” the disclosure of each of which is hereby incorporated by reference herein in their entirety and made part of the present U.S. utility patent application for all purposes.

### BACKGROUND OF THE INVENTION

The described invention relates in general to matching buyers and sellers of audience access opportunities. More specifically, the present invention relates to providing audience access opportunities to interested parties (“buyers”) based on information about performers' (“sellers”) audience demographic characteristics.

For potential buyers, such as corporate marketing departments, finding audience access opportunities is an important aspect of building brand recognition and familiarity. At the same time, performers, such as musicians, athletes, comedians, and speakers, have access to audiences of varying sizes, interests, and demographics. Often, these performers seek out buyers to augment their performance income or widen their audience return on investment. Previously, matching performers and potential buyers was a difficult and time consuming task due to the lack of information about the real time characteristics of the performer's audiences as well as the lack of transparency of potentially interested brand deals. Therefore, identifying such audience access opportunities was an expensive proposition, both in terms of the time and the resources necessary to do so.

Previously, systems for managing solicitation requests and monitoring the solicitation process were used to facilitate the matching process. These systems are analogous to Customer Relationship Management (CRM) that are well known in the art. U.S. Patent Application Publication No. 2011/0113044 to Baskin describes a system of matching sponsors with sponsorship opportunities. The system of Baskin utilizes external demographics databases to approximate the demographics of the audiences of the sponsorship opportunity. However, all of these systems suffer from the drawback that they do not have any specific information about the actual audiences of the performers.

Accordingly, it is desirable to determine real time demographic profiles of the audiences of performers. Furthermore, it is desirable to provide a system for matching performers and buying parties that are interested in reaching the audiences of the performers.

### BRIEF SUMMARY OF THE INVENTION

Briefly stated, in one embodiment, the present invention comprises a method of matching a buyer and a seller of audience access. A plurality of profiles associated with a respective plurality of performers are stored by a computing system. Each of the plurality of performers offers access to an audience having one or more distinct characteristics. At least one of the distinct characteristics of the audience associated with each of the performers is determined. A discovery request is received from a requestor. The discovery request identifies one or more target audience characteristics. The computing system compares the one or more target audience characteristics of the discovery request with the determined at least one of the distinct characteristics of the audience. At least one of the plurality of performers matching the discovery request is identified based on the comparing. The identified at least one performer is output over the network to the requestor.

In another embodiment, an audience access opportunity matching system in accordance with the present invention comprises a seller database which is configured to store, for each of a plurality of performers, (i) performer profile information, and (ii) online fan information associated with the performer. The online fan information identifies one or more characteristics of an audience associated with the performer. An application server receives the online fan information from one or more external sources, and stores the received online fan information in the seller database. A web server receives, over a network, a request from a buyer of audience access. The request includes one or more audience characteristics. The web server outputs at least one matching audience access opportunity to the buyer over the network. A matching server processes the received request to identify at least one matching audience access opportunity based on the online fan information stored in the seller database.

In yet another embodiment, the present invention comprises a computer program product for identifying audience access opportunities, the computer program product including computer-readable media encoded with instructions for execution by a processor to perform the method. A memory stores a plurality of profiles associated with a respective plurality of performers. Each of the plurality of performers offers access to an audience having one or more distinct characteristics. At least one of the distinct characteristics of the audience associated with each of the performers is determined. A discovery request is received from a requestor over a network. The discovery request identifies one or more target audience characteristics. A processor compares the one or more target audience characteristics of the discovery request with the determined at least one of the distinct characteristics of the audience. At least one of the plurality of performers matching the discovery request is identified by the processor based on the comparing. The identified at least one performer is output over the network to the requestor.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a system diagram of an audience access system according to one preferred embodiment of the present invention;

FIG. 2 is a system diagram of a multi-tier architecture of the audience access system of FIG. 1;

FIG. 3 is a flowchart of steps for populating a seller database according to one preferred embodiment of the present invention;

FIG. 4 is a flowchart of steps for computing a performer score according to one preferred embodiment of the present invention;

FIG. 5 is an exemplary database record of performer profile information stored in a seller database according to one preferred embodiment of the present invention;

FIG. 6 is an exemplary database record of performer affinity information stored in a seller database according to one preferred embodiment of the present invention;

FIG. 7 is a flowchart of steps for buyers to identify opportunities for audience access according to one preferred embodiment of the present invention;

FIG. 8 is an exemplary graphical user interface of an audience characteristics selection screen according to one preferred embodiment of the present invention;

FIG. 9 is an exemplary graphical user interface of a performer characteristics selection screen according to one preferred embodiment of the present invention;

FIG. 10 is an exemplary graphical user interface of an event search screen according to one preferred embodiment of the present invention; and

FIG. 11 is a flowchart of steps for negotiating a purchase of an audience access opportunity according to one preferred embodiment of the present invention.

### DETAILED DESCRIPTION OF THE INVENTION

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the stated component and designated parts thereof. Additionally, the words “a” and “an”, as used in the claims and in the corresponding portions of the specification, mean “at least one.” The terminology includes the words above specifically mentioned, derivatives thereof and words of similar import.

A system whereby sellers offer opportunities for audience access to buyers expressing interest in the offered audience access opportunities is described. Generally, a seller is any party offering access to an audience, and a buyer is any party requesting access to an audience for any purpose. Sellers are typically performers, such as musicians, speakers, sports figures, authors, actors, comedians, and the like. A seller may also be a performer's legal representative(s), manager(s), agent(s), promoter(s), presenter(s), venue proprietor(s), and the like. In general, sellers have opportunities for access to audiences of varying sizes, interests, and demographics through performances, events, activities, appearances, and the like. Audience access opportunities may be, for example, use of a musician's song, advertising at an event or a venue, advertising to an online audience, or advertising in a particular medium, for example, a sports jersey, a co-branded concert t-shirt, or a co-branded promotional poster for a particular event or group of events.

Buyers, may be corporate marketing departments, brand managers, public relations and advertising agencies, record companies, music supervisors, account managers, social media managers, and the like. In general, buyers wish to gain access to audiences having particular sizes, interests and/or demographic characteristics. Accordingly, users of the system described herein who are buyers are able to gain access to audiences of varying sizes, interests, geographies, and demographics by identifying, and connecting with users of the system who are sellers that are providing access to their audiences for financial or other (e.g., goods or services) remuneration. For example, a seller may be a musical artist wishing to produce a poster to announce an upcoming show or concert tour, and a buyer may be a corporate marketing department or brand manager that wishes to add a name to the poster.

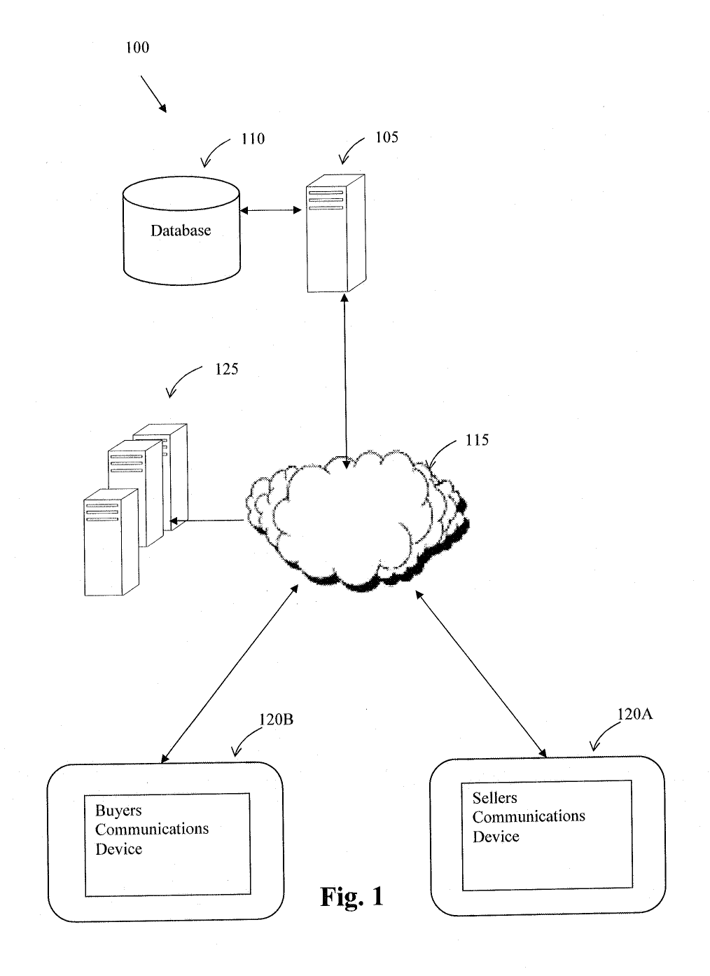

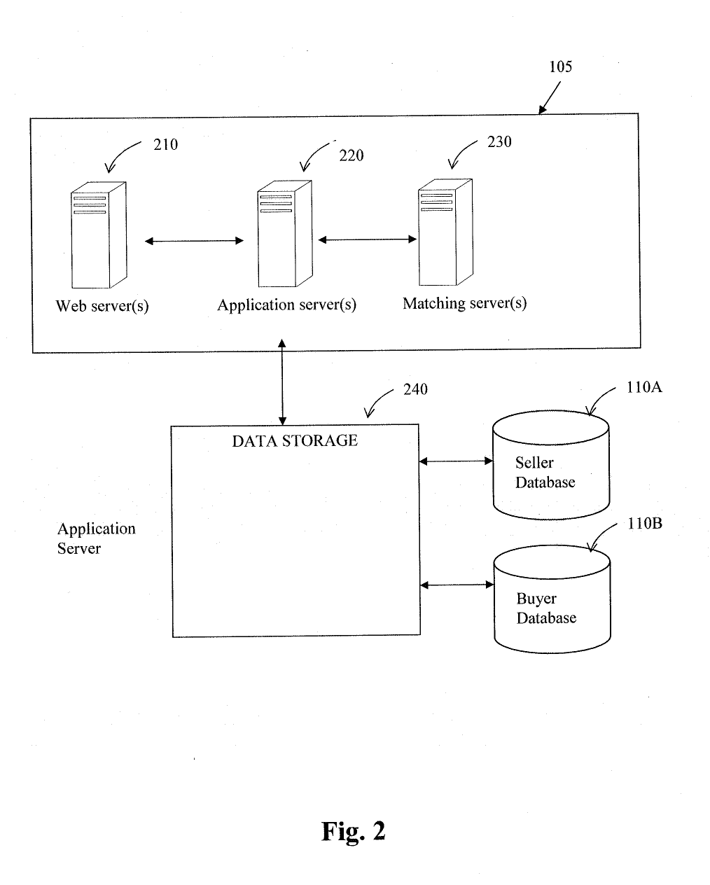

Referring to the drawings in detail, wherein like reference numbers refer to like elements throughout the several figures, an audience access system 100 for matching buyers and sellers of audience access is described. Referring to FIG. 1, the audience access system 100 provides a matching system between sellers and buyers of audience access. The audience access system 100 preferably includes a server-based multi-tier architecture (FIG. 2) having one or more computing devices 105 associated with one or more databases 110A and 110B. The computing devices 105 implement a multi-tiered client-server architecture, or the like. The computing devices 105 perform application processing and data management in the databases 110A and 110B. Application processing and data management are preferably logically separate processes that reside on separate networked hosts, which together are referred to herein as the computing devices 105.

Referring to FIGS. 1 and 2, a multi-tier architecture of the audience access system 100 according to a preferred embodiment is shown. The computing devices 105 are preferably arranged into a multi-tier architecture, including one or more web servers 210 for interacting with the seller communications devices 120A and buyer communications devices 120B over a network 115. The computing devices 105 further preferably include one or more application servers 220 configured to query Applied Programming Interfaces (API) of one or more external sources 125 and process retrieved data, and one or more matching servers 230. A data storage system 240 is connected to the computing devices 105, a seller database 110A and a buyer database 110B. While the seller database 110A and the buyer database 110B are shown as separate databases, in an alternate embodiment, the seller database 110A and the buyer database 110B may be merged into a single database (not shown).

Seller communications devices 120A and buyer communications devices 120B access, and interact with the audience access system 100 over a network 115. The communications devices 120A and 120B and/or the computing devices 105 preferably also interact with one or more external sources 125 over the network 115. In the preferred embodiment, the network 115 is the Internet, and the computing devices 105 communicate with the communications devices 120A and 120B and the external sources 125 using a TCP/IP networking stack. However, in other embodiments, the network 115 could be another type of network, such as a private network LAN, WAN, or the like, and could utilize other networking protocols, such as UDP, as is well known to those skilled in the art. Furthermore, one or more of the computing devices 105 may be physical or virtual servers hosted by one or more third parties.

The communications devices 120A and 120B are, for example, smart phones, tablet computers, laptop computers, desktop computers, and the like, as is well known to those skilled in the art. Each communications device 120A and 120B preferably includes a processor, one or more memories (e.g., RAM, FLASH, Hard Disk Drive) storing executable code thereon, an input device, and an output device such as a display. The input device is, for example, a touchscreen, a keyboard, a trackpad, a mouse, or the like.

A memory of each communications device 120A and 120B stores an application, such as a general purpose web browser or a specialized mobile application provided by an operator of the audience access system 100. The application displays a graphical user interface (transmitted from the web server and/or loaded by the application) allowing the buyers and/or sellers to conveniently interact with the audience access system 100. Communications devices 120A and 120B further include a wired or wireless network interface (not shown) for communicating over the network 115. The network interface is, for example, an Ethernet adapter, a 802.11 Wi-Fi adapter, a cellular antenna, or the like suitable for sending and receiving data over the network 115.

The computing devices 105 are configured to provide services such as transmission of data, resources and functionality to the communications devices 120A and 120B. The databases 110A and 110B may be distributed from the one or more computing devices 105, and connected thereto by the network 115, or another network, such as a Local Area Network (LAN), Wide Area Network (WAN), or the like. As is well known to those skilled in the art, various technologies may be leveraged by the computing devices 105 to facilitate the operation of the audience access system 100. For example, one or more of the computing devices 105 may be provided by a cloud application platform such as HEROKU, RACKSPACE, AMAZON WEB SERVICES, GOOGLE APP ENGINE, MICROSOFT AZURE, or the like. In addition, various other services, such as e-mail services, customer service services, and payment services may be implemented by one or more of the computing devices 105 in the audience access system 100, without departing from the scope of this invention.

Preferably, the databases 110A and 110B support multiple simultaneous connections in a secure and scalable fashion, as is well known to those skilled in the art. Since connectivity to the databases 110A and 110E is resource intensive in terms of initial connections, a pool of connections preferably exists on the computing devices 105 to facilitate access thereto. The databases 110A and 110B are implemented using, for example, MYSQL, MARKLOGIC, COUCHDB, MONGODB, APACHE, or the like, as is well known to those skilled in the art.

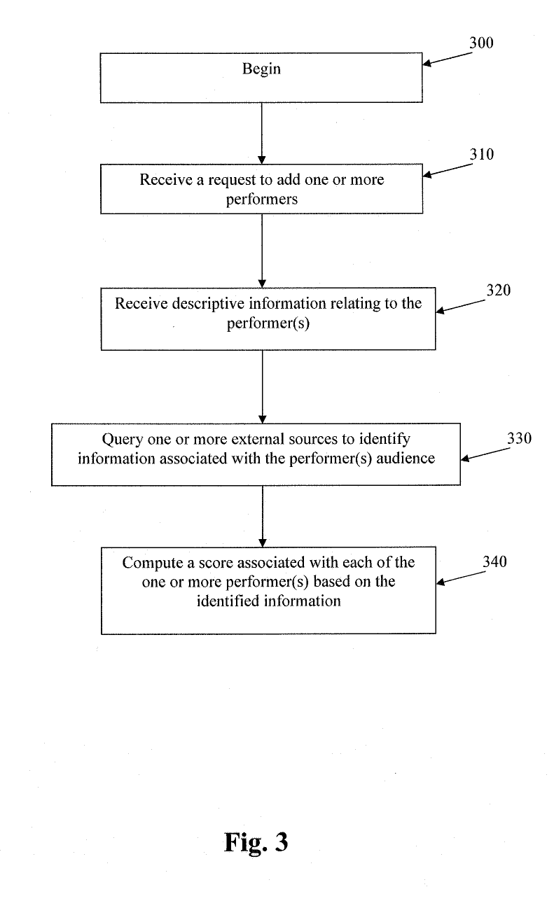

Referring to FIG. 3, a flowchart of steps for populating the seller database 110A according to the preferred embodiment of this invention is shown. The process begins at step 300, and proceeds to step 310, where requests to add one or more performers are received by the computing devices 105 from at least one of the seller communications devices 120A. In one embodiment, a request to add a performer is a request to create a membership account with the audience access system 100. Preferably, a plurality of membership account levels offering increasing amounts of functionality are available, including a free account, and at least one premium account. Even more preferably, the premium account includes additional functionality not available to the free account members. A monthly or annual fee is preferably charged for the premium account. In an alternate embodiment, only the buyers or only the sellers are offered a premium account.

In addition, a performer can be added as a seller on the audience access system 100 by connecting to a profile on a social media platform such as FACEBOOK, TWITTER, MYSPACE, and the like. In this case, profile information for the performer is preferably imported from the linked social media platform. However, the audience access system 100 requires the performer to enter additional membership information, such as an email address, login name, password, and the like.

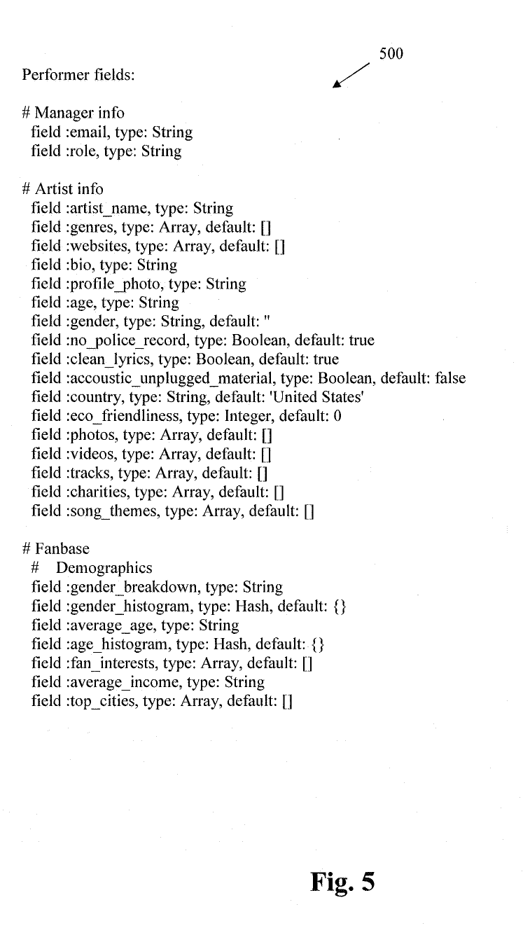

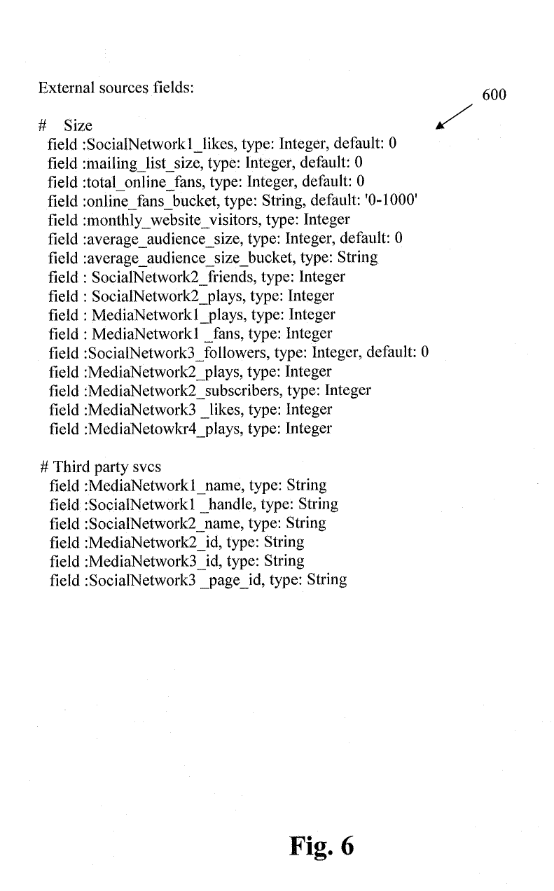

Preferably, a database record (FIGS. 5 and 6) is created or updated in the seller database 110A for each of the performers for which a request is received. Profile information relating to each of the performers is received at step 320, and stored in the seller database 110A. API connections with popular third party services, such as FACEBOOK, TWITTER and MYSPACE, allow some or all of the profile information of the performer to be pre-populated, as discussed above. Pre-populating the profile information improves the user experience, making it easier for performers to sign up for the audience access system 100.

Referring to FIG. 5, profile information of the performer is stored in the seller database 110A in a plurality of fields in a profile database record 500 of the performer. Profile information includes, for example, information such as contact (manager/agent/artist) information, biographical data (e.g., age, gender, etc), mailing list information, website visitor information, fan club information, event information, media information (e.g., photos, songs, videos), and the like. Profile information that is not imported is preferably entered by the seller through one or more web-based fillable forms, drop-down menus, radio buttons, and the like, which lead the seller through the data entry process. In addition, information entered by a seller at step 320 preferably includes data, defining preferred or perceived characteristics of audiences of the seller. For example, the seller may identify their average audience size.

At step 330, the computing devices 105 query one or more external sources 125 to identify online fan information associated with the performer(s). In a preferred embodiment, the external sources 125 are one or more social media websites. The online fan information preferably includes affinity information associated with the performers and user information associated with the affinity information. The external sources 125 preferably provide the online fan information through connections to their respective API.

Online fan information is preferably gathered from social media sites. Social media sites allow fans to interact with performers in a variety of ways that are well known to those skilled in the art. Thus, social media sites are particularly well suited to determining information about audiences of a performer. Social media sites include, but are not limited to, VIMEO, YOUTUBE, TWITTER, FACEBOOK, GOOGLE+, MYSPACE, SPOTIFY, PANDORA, LAST.FM, SOUNDCLOUD, FOURSQUARE, UPCOMING, HYPE MACHINE, and the like. Preferably, the online fan information is periodically updated by the computing devices 105 querying the APIs of external sources 125, for example, on demand, or at predetermined time intervals (e.g., nightly).

Online fan information may also be obtained from other social media sites, whether currently existing, or later developed, in a similar manner to that described herein. While in the preferred embodiment, the online fan information is obtained through connections to the respective APIs, where an API is not provided, online fan information is obtained by other data gathering methods, as is well known to those skilled in the art. For example, data scraping allows retrieving of affinity information and/or user information in the absence of an API.

Affinity information is any information that associates a user with a particular performer. For example, an affinity may be indicated by a user's view of a performer's video, a listen of the performer's song, or a subscription to the performer's social media profile. Thus, affinity information may be an indication of a user's interest or approval of a performer, for example by the user giving the performer or the performer's content a “+1” on GOOGLE PLUS, following the performer on TWITTER, liking the performer's profile page on FACEBOOK, or subscribing to the performer's updates on YOUTUBE. Other affinity information includes listens or views of the performer's media content on media streaming providers.

In addition to the affinity information, user information about users associated with the affinity information is preferably retrieved from the external sources 125 using the provided APIs. The ability to retrieve such user information varies widely depending on the capabilities of the respective APIs, and the terms and conditions for using them. In the case where user information can be retrieved, such user information preferably includes non-personally identifiable demographic information, such as age, gender, and geographic location. For example, the FACEBOOK INSIGHTS API allows retrieving information including, but not limited to, the number of people who “like” a performer's page, fan location (top locales, cities, counties), gender breakdown, and age breakdown, while a YOUTUBE API allows retrieving gender and age breakdown of followers, location of followers, video & channel view counts. APIs provided by other external sources 125 allow retrieving other types of online fan information.

When allowed by the API terms and conditions, the retrieved online fan information is stored in the seller database 110A in the online fan database record 600 associated with the performer. Referring to FIG. 6, an exemplary online fan database record 600 stored in the seller database 110A is shown. Online fan information is preferably stored in the seller database 110A in a plurality of fields in the online fan database record 600 of the performer. While the profile database record 500 and online fan database record 600 of FIGS. 5 and 6 are shown as separate database records, they may also be combined into a single database record (not shown) without departing from the scope of this invention.

At step 340, the seller data is processed to compute a score for each of the performers based on the online fan information. Referring to FIG. 2, the seller data is preferably processed by the application servers 220, or the like. Preferably, the application servers 220 store the business logic and rules for processing the seller data. After processing by the application servers 220, the processed seller data (e.g., the calculated performer score) is preferably stored in the seller database 110A.

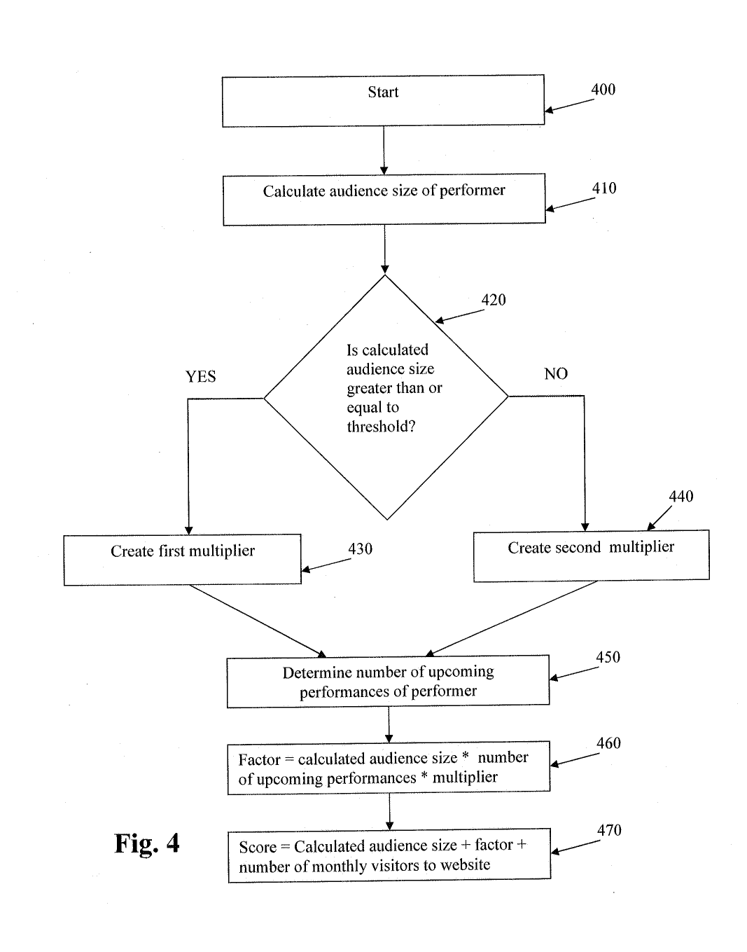

An exemplary algorithm for computing a performer score based on the online fan information is described with reference to the flowchart of FIG. 4. The process begins at step 400, and proceeds to step 410, where the audience size of a performer is computed. To compute the audience size, available sources of audience size data are combined. For example, where available, information about a performer's mailing list received from the seller is combined with online fan information retrieved from the external sources 125.

At step 420, it is determined whether the calculated audience size of the performer is equal to, or greater than, an optional threshold audience size. The optional threshold audience size allows filtering out and/or weighting down performers that have small audiences that may not be of interest to buyers. Such filtering and/or weighting reduces the number of small and/or amateur performers appearing in search results for the buyer. In the preferred embodiment, the threshold audience size is one thousand (1,000) fans. However, those skilled in the art will understand that the threshold audience size can be set to a different number without departing from the scope of this invention.

If the computed audience size at step 420 is equal to, or greater than, the threshold audience size, the process proceeds to step 430. At step 430, a first multiplier is created. If the audience size at step 420 is less than the threshold, the process proceeds to step 440, where a second multiplier is created. Preferably, the first multiplier is one or more magnitudes greater than the second multiplier (e.g., if the first multiplier is one hundred (100), the second multiplier is ten (10)).

At step 450, the number of upcoming performances of the performer is determined. Upcoming performance information is entered by the performer or their representative, or is retrieved by the computing devices 105 over the network 115 from a variety of external sources 125, including, but not limited to, SONGKICK and REVERBNATION. At step 460, the multiplier determined at step 430 or 440 is multiplied by the audience size calculated at step 410, and by the number of upcoming performances determined at step 450.

At step 470, the performer score is calculated by adding the factor calculated at step 460 to the audience size calculated at step 410 and the number of monthly website visitors. The performer score determined at step 470 is stored in the seller database 110A in the performer's profile database record 500. Preferably, the performer score of each performer is used to rank search results displayed in response to a buyer's search request. A code snippet usable by the computing devices 105 for performing the performer score calculation of FIG. 4 is shown below:

COMPUTE PERFORMER SCORE

def compute_rank_factor

fans = self.mailing_list_size + self.total_online_fans
unless self.average_audience_size.nil?

fudge_factor = self.average_audience_size > 300 ?
100 : 10
fans += fudge_factor * self.average_audience_size *

self.performances.upcoming.size

end
unless self.monthly_website_visitors.nil?

fans += self.monthly_website_visitors

end
self.rank_factor = fans

end

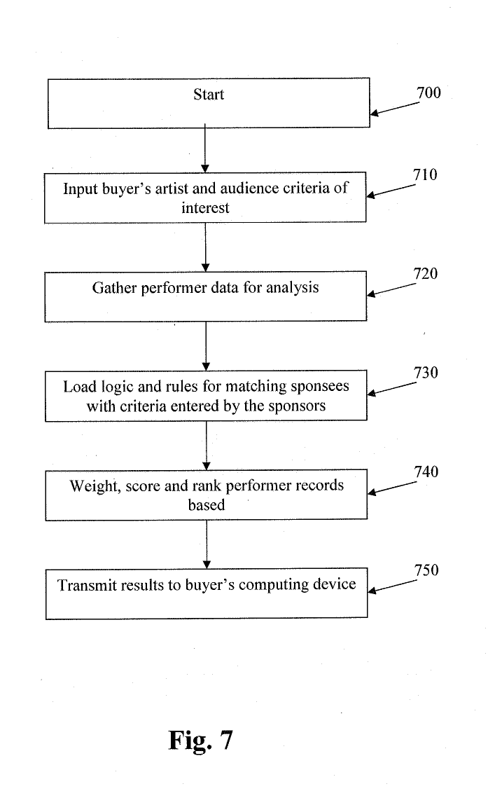

Referring now to FIG. 7, a flowchart of steps for buyers to identify opportunities for audience access according to the preferred embodiment of this invention is shown. The matching process of the audience matching engine begins at step 700, and is triggered by a request received by the computing devices 105 over the network 115 from the buyer communications device 120B. At step 710, the buyer inputs one or more audience access characteristics of interest to the buyer. The computing devices 105 provide one or more web based forms to the buyers communications devices 120B to allow buyers to enter the desired audience access characteristics. The web based forms lead the buyer through the audience and performer preference characteristics selection process. The buyer utilizes the communications device 120B to enter desired audience and performer preference characteristics.

In one embodiment, the buyer is provided an option to select which external sources 125 of data should be used in determining the audience characteristics. For example, the user may be provided with a list of available external sources 125 that may be added to, or removed from, the list of external sources 125 used by the matching servers 230 to perform the matching. An example of such a list of external sources 125 is shown in Table 1 below, but one skilled in the art will understand that the current invention is not limited to any particular list of external sources 125.

TABLE 1

FACEBOOK Fans
MYSPACE Fans
RDIO Fans
REVERBNATION Fans
SOUNDCLOUD Fans
TWITTER Fans
YOUTUBE Fans

Since, in the preferred embodiment, online fan information is received from a plurality of external sources 125, it is likely that the same users appear in multiple ones of the data sets retrieved from the external sources 125. For example, a user may follow the band COLDPLAY on FACEBOOK, TWITTER, and YOUTUBE. This effect is especially likely where performers have strong social media presences. Where multiple external sources 125 are selected by a buyer, prior to outputting results, the data sets from the external sources 125 are optionally processed to identify and cross-reference online fan information from the multiple selected external sources 125.

Various techniques for cross-referencing users are known to those skilled in the art. For example, where an individual identifier, such as an IP Address, e-mail address, physical address, or user name is available, the online fan information associated with the same individual identifier is cross-referenced. In this way, a user of multiple external sources 125 is reachable by a buyer across the multiple external sources 125 to allow for a more effective audience access opportunity for the buyer.

Once the optional cross-referencing of online fan information is completed, in one embodiment, online fan information showing a user to be associated with a performer on multiple external sources 125 is weighted more heavily than online fan information showing a user to be associated with a performer on fewer external sources 125. That is, a user that is associated with a performer on a plurality of distinct social media networks is considered to be a bigger fan of the performer than another user who is associated with the same performer on only one external source 125. In this way, a core audience of a performer is determined by aggregating information from multiple external sources 125. After the external sources 125 to be included in the matching are selected, the buyer selects one or more artist and audience characteristics to be matched.

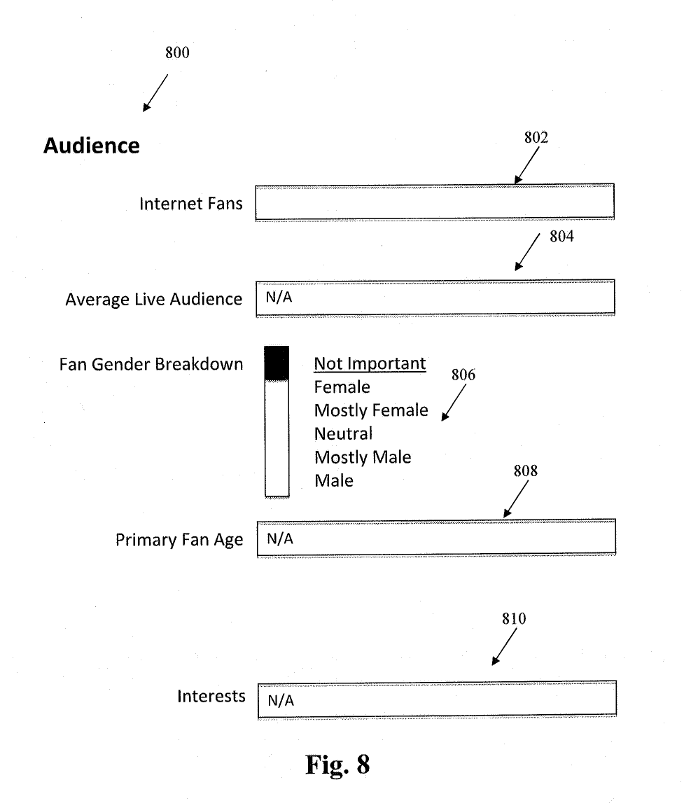

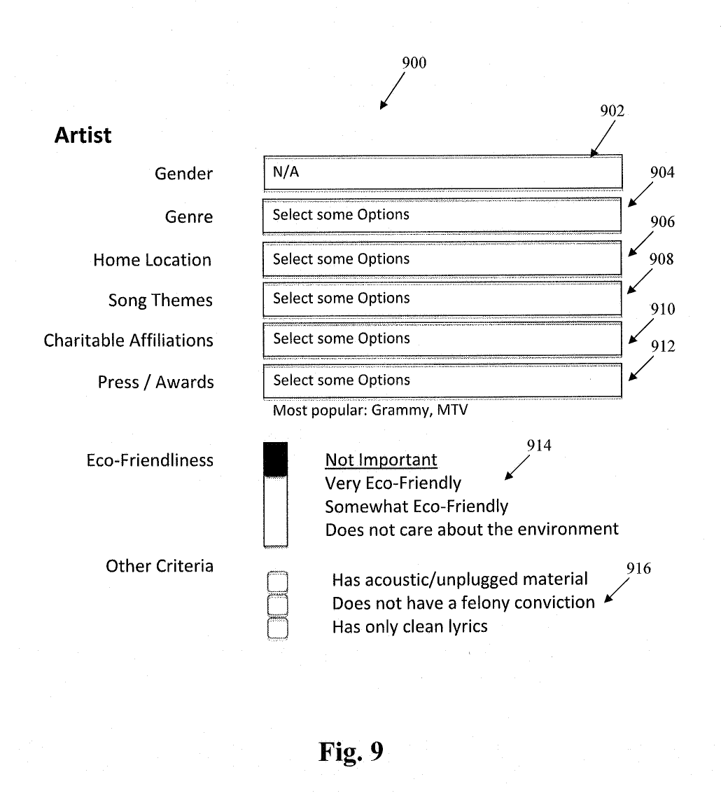

Referring to FIGS. 8 and 9, the buyer makes selections using an audience characteristics selection screen 800 and a performer data selection screen 900 to identify performers having performer and audience characteristics suitable to the buyer. An exemplary audience characteristics selection screen 800 is shown in FIG. 8. The audience characteristics selection screen 800 allows a buyer to select desired audience characteristics. For example, the buyer inputs and/or selects fields for one or more desired fields, including number of Internet fans 802, average live audience size 804 (e.g., based on size/capacity or location of venue(s) performed), fan gender breakdown 806 (e.g., Female (0-10% Male and 90-100% Female), Male-Female Same (40-60% Male, 40-60% Female), Male (90-100% Male, 0-10% Female)), primary fan age 808 (e.g., 13-17, 18-24, 25-34, 35-44, 45-54, 55+), and interests 810. These audience characteristics are preferably compared to the online fan information received from the external sources 125 which are stored in the online fan database record 600.

An exemplary performer data selection screen 900 is shown in FIG. 9. The performer data selection screen 900 allows a buyer to optionally select performer data, such as gender 902, music genre 904 (e.g., Alternative, American Roots, Children's, Classical, Classical, Comedy, Country, Dance, Disco, Electronic, Gospel, Jazz, Latin, Musical Show, New Age, Polka, Pop, R&B, Rap, Reggae, Remixer, Rock, Spoken Word, World), home location 906 (e.g., city/state/country), song themes and/or artist moods 908 (e.g., Elegant, Romantic, Smooth, Soft, Sophisticated), charitable affiliations 910, press and awards 912, eco-friendliness 914, and other characteristics 916 (e.g., acoustic/unplugged material, police record, clean lyrics). Preferably, performer characteristics selected in the performer data selection screen 900 are compared to the performer profile database record 500 stored in the seller database 110A. In one embodiment, the buyer selects weights for the various characteristics using one or more sliders, or the like (not shown).

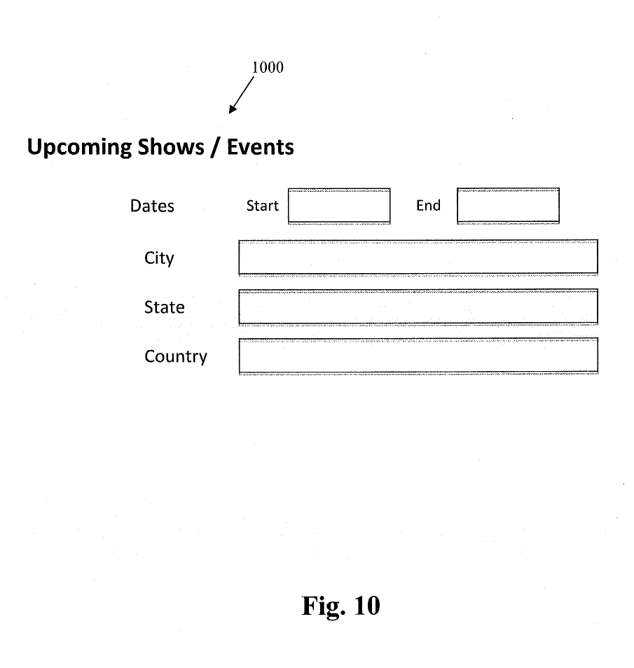

Referring to FIG. 10, event information is preferably also searchable by the buyers. For example, buyers of audience access may have a new product launch that they want to advertise during a particular time frame. A performer may have a new CD release or a tour coming that coincides with the product launch. Accordingly, the optional event search screen 1000 of FIG. 10 allows buyers to identify sellers having audience opportunities matching the audience and performer characteristics selected in the audience characteristics selection screen 800 and the performer data selection screen 900, filtered based on performers having events occurring during the desired time frame, and in the desired geographic location.

Any selections of the buyer in the audience characteristics selection screen 800, the performer data selection screen 900, and the event search screen 1000 are submitted over the network 115 to the computing devices 105 for matching against the profile database record 500 and the online fan database record 600 stored in the seller database 110A. Upon the computing devices 105 receiving the submitted selections of the buyer, at step 720, the submitted selections of the buyer are preferably translated into database search criteria, such as Structured Query Language (SQL) format. Receipt of the buyer's selections triggers an audience matching engine executed by the matching servers 230. The audience matching engine determines scoring and ranking of sellers based on the characteristics submitted by the buyers, by processing the performer and audience information stored in the seller database 110A. Thereafter, a plurality of performer records are gathered from the seller database 110A for analysis. Where a buyer selects a subset of external sources 125 to be used in the analysis, the data sets gathered at step 720 take into account the buyer's selection(s).

In an alternate embodiment, when the user selects the desired characteristics, the computing devices 105 query the external sources 125 to retrieve updated online fan information. In this case, the required datasets reside on separate logical hosts (i.e., the respective external sources 125). At step 730, logic and rules for matching sellers with characteristics entered by the buyers are loaded by the matching servers 230.

At step 740, the profile database records 500 loaded from the seller database 110A are weighted, scored and ranked by the matching servers 230 based on the buyer's characteristics. The matching servers 230 filter out performers that do not match the characteristics required by the buyer (i.e., based on audience characteristics, performer characteristics, and/or event characteristics). For example, when a buyer fills out the event search screen 1000, the matching servers 230 preferably filter out any performers in the seller database 110A that do not have any matching events.

In the preferred embodiment, the remaining list of performers is sorted based on the performer score. That is, all performers in the seller database 110A not matching the buyer's criteria are filtered from the search results, and the remaining performers are sorted based on the performer scores. The performer scores are preferably converted to percentages, with the performer having the highest score receiving a one hundred percent (100%). Performers having lower scores are normalized to the performer with the highest score. Thus, the buyer is preferably never shown the raw performer score(s), but is only shown a normalized list of performers matching the buyer's search criteria.

The ranked results of available sellers are transmitted back to the buyer at step 750. Preferably, the list of performers is matched and transmitted to the buyer communications device 120B in real time or substantially real time, for example, within a few seconds or less from a submission of a request by a buyer. In one embodiment, the matching servers 230 process the buyer's selections in substantially real time, providing a list, or a raw count, of performers matching the buyer's selected characteristics. Such real time processing by the matching servers 230 allows the buyer to quickly fine tune the selection characteristics to return a suitable list of performers. When a list of performers matching the characteristics desired by the buyers is identified, the results are provided to the buyer communications device 120B over the network 115.

The selections of the buyer in the audience characteristics selection screen 800 and the performer data selection screen 900 that are received by the computing devices 105 from the buyer communications devices 120B are preferably stored in a buyer record (not shown) in the buyer database 110B. In this way, subsequent searching by the buyer is simplified, and updated search results are sent by the computing devices 105 over the network 115 to the buyer communications device 120B periodically. Furthermore, storage of the buyer's preferences in the buyer database 110B allows a seller to search for potential buyers.

While the system has been described in terms of a buyer searching a seller database 110A for a matching performer generally, the audience access system 100 preferably allows performers to provide specific audience access opportunities. In this case, a performer updates the profile database record 500 stored in the seller database 110A with information about specific audience access opportunity or opportunities of the performer. For example, a performer adds information about scheduled events, appearances, printing of advertising such as a promotion poster or tour merchandise, and the like. A price associated with each specific audience access opportunity is preferably provided by the seller, and may be accepted by interested buyers. One skilled in the art will understand that the types of audience access opportunities that can be listed by performers is nearly endless. Each such audience access opportunity may be included in the audience access system 100 without departing from the scope of this invention.

Where specific audience access opportunities are made available by performers, preferably the performers utilize their seller communications devices 120A to create and submit such listings to the computing devices 105 for storage in their profile database record 500 of the seller database 110A. Preferably, the performers define the specific audience access opportunity by providing additional information, such as demographics of the desired audience for the specific audience access opportunity. Listings for each of the specific audience access opportunities are stored in the seller database 110A.

When available, the specific audience access opportunity listings are preferably included in the matching engine of FIG. 7. That is, the matching engine of FIG. 7 identifies audience access opportunities generally by identifying performers matching the buyer's requirements, and identifies specific audience access opportunities by searching the performers' listings stored in the seller database 110A. Preferably, the results transmitted at step 750 of FIG. 7 are sorted based on whether the identified opportunity is a performer or a particular audience access opportunity. Furthermore, if desired, the buyer can filter out either general audience access opportunities or specific audience access opportunities.

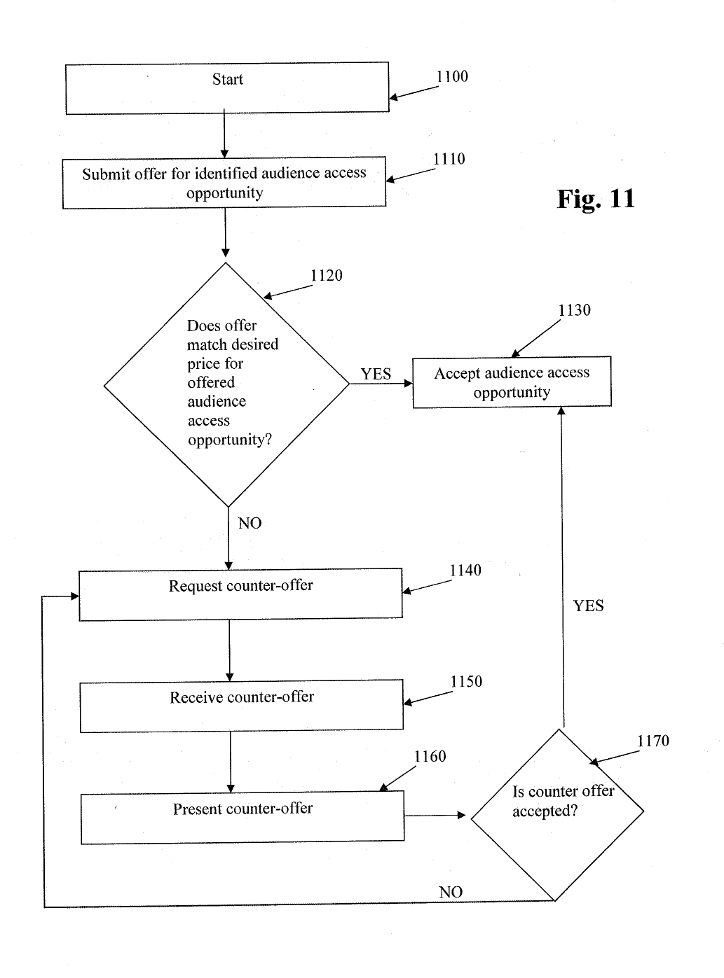

Referring to FIG. 11, a flowchart for negotiating the purchase of an audience access opportunity is shown. The process begins at step 1100 when a buyer identifies an audience access opportunity of interest from the search results received in the matching process of FIG. 7. In one embodiment, the negotiation is facilitated by the computing devices 105 between the buyers and sellers directly. In another embodiment, the negotiation is facilitated by a manual or automated broker that knows the terms needed for a successful transaction to be completed. Such rules are preferably specific to the needs and requirements of the individual seller and/or buyer. That is, the broker knows the maximum amount the buyer is willing to pay for a particular audience access opportunity in terms of currency, goods and/or services, and the minimum that the seller will accept for the desired audience access opportunity.

At step 1110, the buyer submits an offer for a desired audience access opportunity using their respective buyer communications device 120B. The offer is transmitted over the network 115 to the computing devices 105. At step 1120, if a desired price of the seller is available, the computing devices 105 determine whether the offer is accepted by comparing the offer with the desired price. If the offer is acceptable, the audience access opportunity is accepted at step 1130. If an audience access opportunity is accepted, preferably the particular opportunity is deactivated in the seller database 110A so that other buyers will not be able to see and/or bid on an accepted audience access opportunity.

If a price is not available, or if the offer does not match the seller's desired price, at step 1140, a counter-offer is requested. The seller provides a counter offer to the computing devices 105 at step 1150 using the seller communications device 120A, which is presented to the buyer at step 1160. At step 1170, it is determined whether the buyer accepts the counter offer, and if so, the audience access opportunity is accepted at step 1130. If the buyer does not accept the counter offer, the process returns to step 1140, where the buyer is requested to make a counter-offer. Preferably, the offer/counter-offer process is an interactive process in which proposals from buyers are delivered to sellers, and proposals from sellers are delivered to buyers. The counter-offer process can be aborted at any time by either party in the negotiation. If the counter-offer process for an audience access opportunity is aborted, preferably the audience access opportunity remains active in the audience access system 100, and is searchable and buyable by other buyers. In one optional embodiment, upon acceptance of an audience access opportunity, the computing devices 105 generate a contract between the seller and the buyer.

The computing devices 105 optionally query the seller and/or the buyer for feedback regarding the transaction (or lack thereof). Three distinct types of feedback are sought. First, regardless of whether a transaction was consummated, participants of the audience access system 100 submit ratings of the match(es) identified by the matching process of FIG. 7. In a preferred embodiment, an easy-to-use graphical user interface (not shown), such as an up arrow and a down arrow are displayed next to each matching result, and the user clicks the up arrow for high quality matches, and the down for low quality matches. This feedback information is utilized to improve the matching process of FIG. 7.

Second, when a transaction between a buyer and a seller is completed, the participants to the transaction are given the opportunity to submit a rating of the participant with whom they interacted in their transaction. That is, participants rate each other based on their transaction experience. The participant is provided with a graphical user interface, for example a slider bar, a drop-down menu, a button input, or the like, which allows one participant to indicate an overall rating for another participant. A variety of feedback mechanisms for rating participants are known to those skilled in the art, and may be implemented herein without departing from the scope of this invention. Furthermore, a variety of feedback criteria may be used for receiving feedback from participants. Such criteria includes ease of execution of the transaction, fair dealing with participants, fair exchange, clear communication, audience contentment, campaign initiatives and goal achievement, and the like.

Third, when a transaction was not completed, feedback information is solicited as to why the transaction was not completed. Such information relates to the quality of the identified match between buyer and seller, and to the negotiation process of FIG. 11.

It will be appreciated by those of ordinary skill in the art that changes and modifications may be made to the embodiments described above without departing from the spirit and scope of the invention. Therefore, the present invention is not limited to the embodiments described above but is intended to cover all such modifications within the scope and spirit of the invention.

We claim:

1. A method of identifying audience access opportunities, the method comprising:
(a) storing, by a computing system, a plurality of profiles associated with a respective plurality of performers, each of the plurality of performers offering access to an audience having one or more distinct characteristics;
(b) determining, by the computing system, at least one of the distinct characteristics of the audience associated with each of the performers;
(c) receiving, by the computing system, over a network, a discovery request from a requestor, the discovery request identifying one or more target audience characteristics;
(d) comparing, by the computing system, the one or more target audience characteristics of the discovery request with the determined at least one of the distinct characteristics of the audience;
(e) identifying, by the computer system, at least one of the plurality of performers matching the discovery request based on the comparing of step (d); and
(f) outputting, over the network, the identified at least one performer to the requestor.

2. The method of claim 1, wherein the determining at least one of the distinct characteristics of the audience further comprises:
(i) connecting, by the computing system, to one or more external sources; and
(ii) receiving, by the computing system, from the one or more connected external sources, affinity information associated with the performers.

3. The method of claim 2, wherein the connecting further comprises accessing an Applied Programming Interface (API) provided by the respective one or more external sources.

4. The method of claim 2, further comprising receiving user information associated with the affinity information.

5. The method of claim 4, wherein the user information further comprises non-personally identifiable demographic information of users associated with the affinity information.

6. The method of claim 2, wherein the one or more external sources are selected by the requestor.

7. The method of claim 1, wherein at least one of the one or more target audience characteristics received in the discovery request is a desired audience size.

8. An audience access opportunity matching system comprising:
(a) a seller database configured to store, for each of a plurality of performers:
(i) performer profile information, and
(ii) online fan information associated with the performer, the online fan information identifying one or more characteristics of an audience associated with the performer;
(b) an application server configured to:
(i) receive the online fan information from one or more external sources, and
(ii) store the received online fan information in the seller database;
(c) a web server configured to:
(i) receive a request from a buyer, over a network, the request including one or more target audience characteristics, and
(ii) output at least one matching audience access opportunity to the buyer over the network; and
(d) a matching server configured to process the received request to identify at least one matching audience access opportunity based on the online fan information stored in the seller database.

9. The audience access opportunity matching system of claim 8, wherein the application server is further configured to connect to an API provided by the respective one or more external sources.

10. The audience access opportunity matching system of claim 9, wherein the online fan information comprises affinity information received from one or more external sources.

11. The audience access opportunity matching system of claim 10, wherein the online fan information comprises user information associated with the affinity information.

12. The audience access opportunity matching system of claim 11, wherein the user information is non-personally identifiable demographic information.

13. The audience access opportunity matching system of claim 12, wherein the non-personally identifiable demographic information comprises at least one of age, gender, and geographic location.

14. The audience access opportunity matching system of claim 10, wherein at least one of the one or more external sources is a social media network.

15. The audience access opportunity matching system of claim 8, wherein the request received by the web server further comprises an identifier of a desired audience size, and the matching server compares the identifier of the desired audience size with the affinity information for the performer.

16. The audience access opportunity matching system of claim 8, wherein the at least one audience access opportunity identified by the matching server is at least one matching performer selected from the plurality of performers stored in the seller database.

17. The audience access opportunity matching system of claim 16, wherein the web server is further configured to receive, from a seller, a description of a particular audience access opportunity associated with the matching performer, and wherein the matching server identifies the particular audience access opportunity in response to the request from the buyer.

18. The audience access opportunity matching system of claim 8, wherein the application server is further configured to implement a negotiation process for sale of an identified audience access opportunity over the network.

19. The audience access opportunity matching system of claim 8, further comprising:
(e) a buyer database configured to store the received requests from the buyers, wherein the web server is further configured to receive a request to identify a buyer from a seller, and the matching server is further configured to identify a buyer by comparing the requests stored in the buyer database to the request received from the seller.

20. A computer program product for identifying audience access opportunities, the computer program product comprising computer-readable media encoded with instructions for execution by a processor to perform a method comprising:
(a) storing, by a memory, a plurality of profiles associated with a respective plurality of performers, each of the plurality of performers offering access to an audience having one or more distinct characteristics;
(b) determining, by a processor, at least one of the distinct characteristics of the audience associated with each of the performers;
(c) receiving, over a network, a discovery request from a requestor, the discovery request identifying one or more target audience characteristics;
(d) comparing, by the processor, the one or more target audience characteristics of the discovery request with the determined at least one of the distinct characteristics of the audience;
(e) identifying, by the processor, at least one of the plurality of performers matching the discovery request based on the comparing of step (d); and
(f) outputting, over the network, the identified at least one performer to the requestor.
